(19) United States
(12) Patent Application Publication
(10) Pub. No.: US 2023/0059248 A1
(43) Pub. Date: Feb. 23, 2023

(54) RESOURCE EFFICIENT COMPONENT PLACEMENT IN A DISTRIBUTED STORAGE SYSTEM

(71) Applicant: VMware, Inc., Palo Alto, CA (US)

(72) Inventors: Yiqi XU, Mountain View, CA (US); Enning XIANG, San Jose, CA (US)

(21) Appl. No.: 17/404,839

(22) Filed: Aug. 17, 2021

(51) Int. Cl. G06F 3/06

(52) U.S. Cl. CPC G06F 3/0616; G06F 3/0619; G06F 3/0664; G06F 3/067; G06F 3/0689

(57) ABSTRACT

An example method of placing a durability component in a redundant array of independent/inexpensive disks (RAID) tree of an object stored in a virtual storage area network (vSAN) of a virtualized computing system is described. The method includes identifying a base component in the RAID tree that is unavailable due to a failure in the virtualized computing system; searching the RAID tree, from a level of the base component towards a root of the RAID tree, for a selected level to place a durability component that protects at least the base component, the selected level satisfying at least one of a plurality of constraints; and provisioning the durability component at the selected level of the RAID tree, the selected level being above the level of the base component in the RAID tree.

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

A virtualized computing system can provide shared storage for applications to store their persistent data. One type of shared storage is a virtual storage area network (vSAN), which is an aggregation of local storage devices in hosts into shared storage for use by all hosts. A vSAN can be a policy-based datastore, meaning each object created therein can specify a level of replication and protection. A vSAN achieves replication and protection using various redundant array of independent/inexpensive disks (RAID) schemes.

RAID is a technology to virtualize a storage entity (such as a disk, object, a flat-layout address space file, etc.) using multiple underlying storage devices. Its main benefits include data availability with multi-way replication or redundancies and performance improvements using striping. RAID1 employs data mirroring across disks and exhibits both benefits for reads. RAID5/6 employs erasure coding to spread parity across disks and provides a middle ground, balancing both space usage and availability guarantees. Some RAID configurations employed by vSAN include stacking of multiple layers of RAID policies, such as RAID1 over RAID0 (striping), RAID 1 over RAID5, etc.

A vSAN can provision durability components for objects stored thereon. A durability component receives writes temporarily for some offline component of an object, which guarantees durability even if a permanent failure follows the abovementioned transient failure. Durability components are placed at the leaf-level of the RAID tree as a mirror of a base component being protected. A durability component exactly mirrors a leaf node in the RAID tree (a component) and thus owns the same address space of its mirror it intends to protect (the base). That is, after the creation of the durability component, regardless of what was written on the base before: the distributed storage software does not replicate the previously written blocks from the base onto the durability component. For non-overlapped address spaces, a durability component can be created for each of the address spaces, such as children under RAID0 or concatenated RAID nodes. As an object size and the object count in the cluster grow, such a scheme could produce many durability components resulting in inefficient use of vSAN resources.

### BRIEF DESCRIPTION OF THE DRAWINGS

FIG. 1 is a block diagram of a virtualized computing system in which embodiments described herein may be implemented.

FIG. 2 is a block diagram depicting distributed storage Object structure according to embodiments.

FIG. 3A is a block diagram depicting a RAID tree for a distributed storage object.

FIG. 3B is a block diagram depicting RAID tree of FIG. 3A having durability components.

FIG. 4A is a block diagram depicting another RAID tree for a distributed storage object.

FIG. 4B is a block diagram depicting RAID tree of FIG. 4A with a durability component.

FIGS. 5A-C are block diagrams depicting RAID trees for distributed storage objects having durability components placed according to embodiments.

FIG. 6 is a flow diagram depicting a method for address-aware placement of a durability component in a RAID tree of a distributed storage object according to embodiments.

FIG. 7A is a block diagram depicting a RAID tree for an object having durability components placed at the leaf-level.

FIG. 7B is a block diagram depicting a RAID tree for an object having a durability component placed according to a per-fault domain technique according to embodiments.

### DETAILED DESCRIPTION

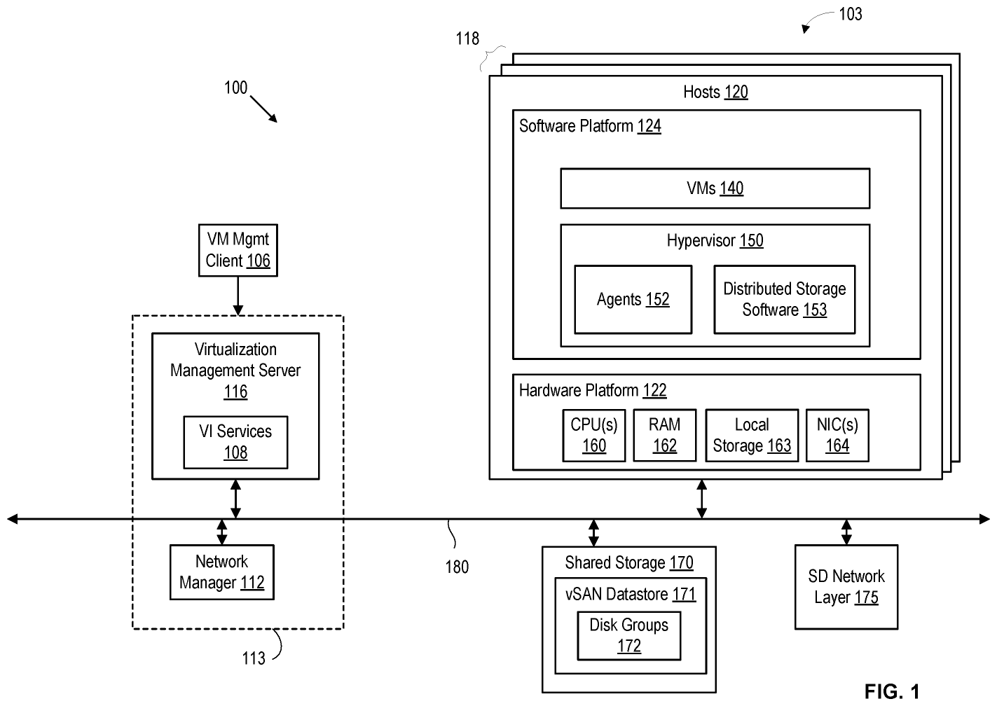

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, one or more host bust adaptors (HBAs), and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein).

In the embodiment illustrated in FIG. 1, hosts 120 can access shared storage 170 by using NICs 164 to connect to network 180. Shared storage 170 may comprise magnetic disks, solid-state disks (SSDs), flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN) datastore 171. Virtualization management server 116 can select which local storage devices in hosts 120 are part of a vSAN for host cluster 118. The vSAN datastore 171 in shared storage 170 includes disk groups 172. Each disk group 172 includes a plurality of local storage devices 163 of a host 120. Each disk group 172 can include cache tier storage (e.g., SSD storage) and capacity tier storage (e.g., SSD, magnetic disk, and the like storage).

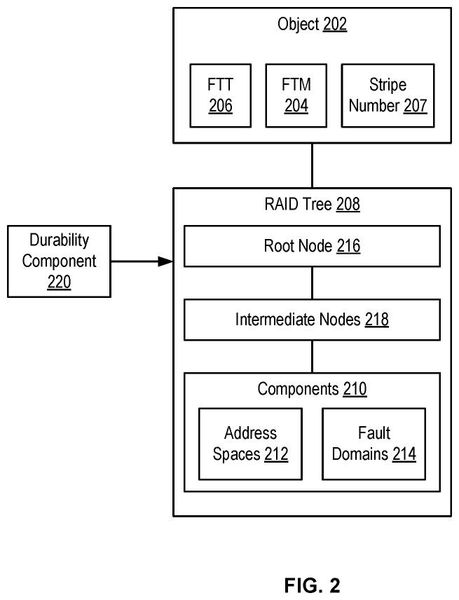

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif. An embodiment of software platform 124 is discussed further below with respect to FIG. 2.

In embodiments, host cluster 118 is configured with a software-defined (SD) network layer 175, SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure.

Virtualization management server 116 is a physical or virtual server that manages host cluster 118 and the virtualization layer therein. Virtualization management server 116 installs agent(s) 152 in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents 152 in hypervisor 150 to add a host 120 as a managed entity, referred to as a transport node. In this manner, host duster 118 can be a cluster 103 of transport nodes. One example of an SD networking platform that can be configured and used in embodiments described herein as network manager 112 and SD network layer 175 is a VMware NSX® platform made commercially available by VMware, Inc. of Palo Alto, Calif. If network manager 112 is absent, virtualization management server 116 can orchestrate SD network layer 175.

Virtualization management server 116 and network manager 112 comprise a virtual infrastructure (VI) control plane 113 of virtualized computing system 100. In embodiments, network manager 112 is omitted and virtualization management server 116 handles virtual networking. Virtualization management server 116 can include VI services 108. VI services 108 include various virtualization management services, such as a distributed resource scheduler (DRS), high-availability (HA) service, single sign-on (SSO) service, virtualization management daemon, vSAN service, and the like.

A VI admin can interact with virtualization management server 116 through a VM management client 106. Through VM management client 106, a VI admin commands virtualization management server 116 to form host cluster 118, configure resource pools, resource allocation policies, and other cluster-level functions, configure storage and networking, and the like.

Hypervisor 150 further includes distributed storage software 153 for implementing vSAN datastore 171 on host cluster 118. Distributed storage software 153 manages data in the form of distributed storage objects (“objects”). An object is a logical volume that has its data and metadata distributed across host cluster 118 using distributed RAID configurations. Example objects include virtual disks, swap disks, snapshots, and the like. An object includes a RAID tree or a concatenation of RAID trees. Components of an object are leaves of the object's RAID tree(s). That is, a component is a piece of an object that is stored on a particular capacity disk or cache and capacity disks in a disk group 172.

A VM 140 or virtual disk thereof can be assigned a storage policy, which is applied to the object. A storage policy can define a number of failures to tolerate (FTT), a failure tolerance method, and a number of disk stripes per object. The failure tolerance method can be mirroring (RAID1) or erasure coding (RAID5 with FTT=1 or RAID6 with FTT=2), The FTT number is the number of concurrent host, network, or disk failures that may occur in cluster 118 and still ensure availability of the object. For example, if the failure tolerance method is set to mirroring, the mirroring is performed across hosts 120 based on the FTT number (e.g., two replicas across two hosts for FTT=1, three replicas across three hosts for FT=2, and so on). If the failure tolerance method is set to erasure coding, and FTT is set to one, four RAID5 components are spread across four hosts 120. If the failure tolerance method is set to erasure coding, and PTT is set to two, six RAID6 components are spread across six hosts 120. In embodiments, hosts 120 can be organized into fault domains, where each fault domain includes a set of hosts 120 (e.g., a rack or chassis). In such case, depending on the FTT value, distributed storage software 153 ensures that the components are placed on separate fault domains in cluster 118.

The disk stripe number defines the number of disks across which each component of an object is striped. If the failure tolerance method is set to mirroring, a disk stripe number greater than one results in a RAID0 configuration with each stripe having components in a RAID1 configuration. If the failure tolerance method is set to erasure coding, a disk stripe number greater than one results in a RAID0 configuration with each stripe having components in a RAID5/6 configuration. In embodiments, a component can have a maximum size (e.g., 255 GB). For objects that need to store more than the maximum component size, distributed storage software 153 will create multiple stripes in a RAID0 configuration such that each stripe satisfies the maximum component size constraint.

Distributed storage software 153 also provisions durability components for objects when necessary. With FTT set to one, an object can tolerate a failure. However, a transient failure followed by a permanent failure can result in data loss. Accordingly, distributed storage software 153 can provision a durability component during planned or unplanned failures. Unplanned failures include network disconnect, disk failures, and host failures. Planned failures include a host entering maintenance mode. When a component fails, distributed storage software 153 provisions a durability component for the failed component (referred to as the base component). During the failure, the writes of the base component are redirected to the durability component. When the base component recovers from the transient failure, distributed storage software 153 resynchronizes the base component with the durability component and the durability component is removed. Techniques for placing a durability component in a RAID tree of an object are described further herein.

FIG. 2 is a block diagram depicting distributed storage object structure according to embodiments. An object 202 is configured according to a storage policy defined for a VM or data item being stored in the object (e.g., virtual disk). The storage policy applied to object 202 includes an FTT number 206, a failure tolerance method (FTM) 204, and a stripe number 207. Distributed storage software 153 stores data for object 202 in a RAID tree 208 that satisfies FTT 206, FTM 204, and stripe number 207, as well as external constraints (e.g., component maximum size). Example RAID trees include RAID1 mirroring, RAID5/6 erasure encoding, RAID0 striping, and combinations thereof. RAID tree 208 includes a root node 216, optional intermediate nodes 218, and components 210. Root node 216 can be a node for object 202. Intermediate nodes 218 can be RAID0, RAID1, RAID5/6, or concatenation (CONCAT) nodes. Components 210 are pieces of object 202 stored on physical disks across hosts. Components 210 are logically related to address spaces 212 and fault domains 214. Components of a RAID1 or RAID5/6 configuration share an address space. Components of a RAID0 have different address spaces (e.g., one for each stripe). In case of component failure, distributed storage software 153 provisions a durability component 220. Distributed storage software 153 employs techniques described herein to place durability component 220 efficiently within RAID tree 208.

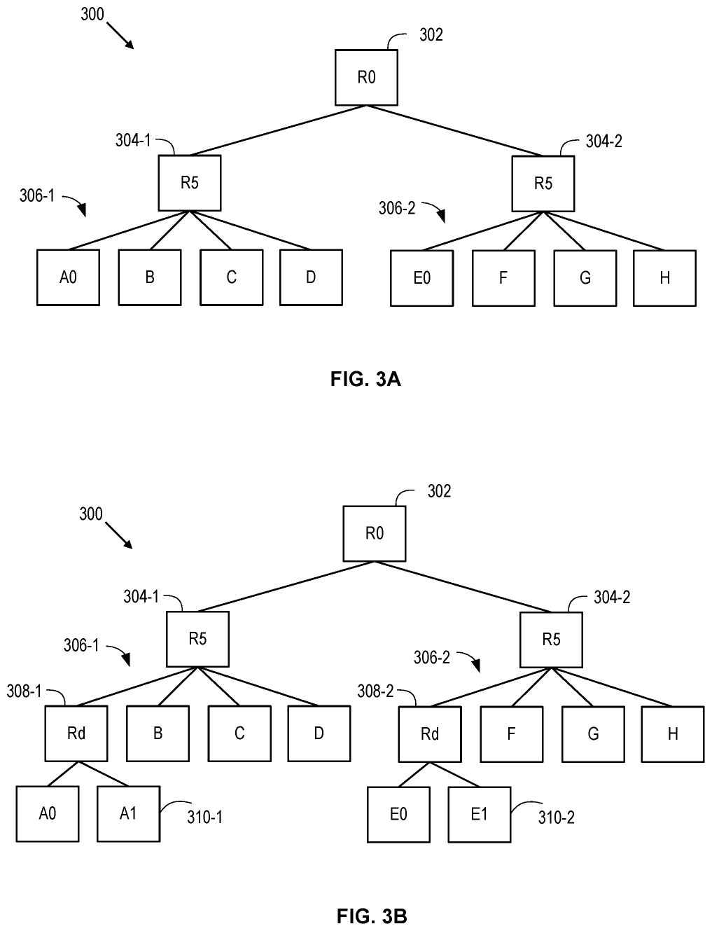

FIG. 3A is a block diagram depicting a RAID tree 300 for a distributed storage object. In the example, the storage policy is FTT set to one, FTM set to erasure coding, and number of stripes set to two. RAID tree 300 includes an RATIO intermediate node 302 with two stripes. One stripe is stored by an intermediate RAID5 node 304-1, and the other stripe is stored by an intermediate RAID5 node 304-2. RAID5 node 304-1 includes four components 306-1 designated A0, B, C, and D. RAID5 node 304-2 includes four components 306-2, designated E0, F, G, and H. Assume a failure (planned or unplanned) causes components A0 and ED to become unavailable. In such case, distributed storage software 153 can provision durability components for A0 and E0 using a leaf mirroring scheme.

FIG. 3B is a block diagram depicting RAID tree 300 of FIG. 3A having durability components. In this example, distributed storage software 153 creates RAID_DELTA components 308-1 and 308-2 for components A0 and E0, respectively. RAID_DELTA component 308-1 includes the base component A0 and a durability component 310-1 designated A1. RAID_DELTA component 308-2 includes the base component. E0 and a durability component 310-2 designated E1.

RAID 300 tree in FIGS. 3A-B is an example showing non-overlapping address spaces. Component A0 is in a different address space than component E0. Thus, a durability component can be provisioned for each of components A0 and E0. In the example of FIG. 3B, the durability components A1 and E1 are placed at the leaf-level of the RAID tree. However, if there are many objects impacted by the unavailable hosts and/or if the object is large having many stripes, placing the durability components at the leaf-level can lead to a large number of durability components, resulting in inefficient usage of vSAN resources. A concatenation of RAID nodes is another example of non-overlapping address spaces.

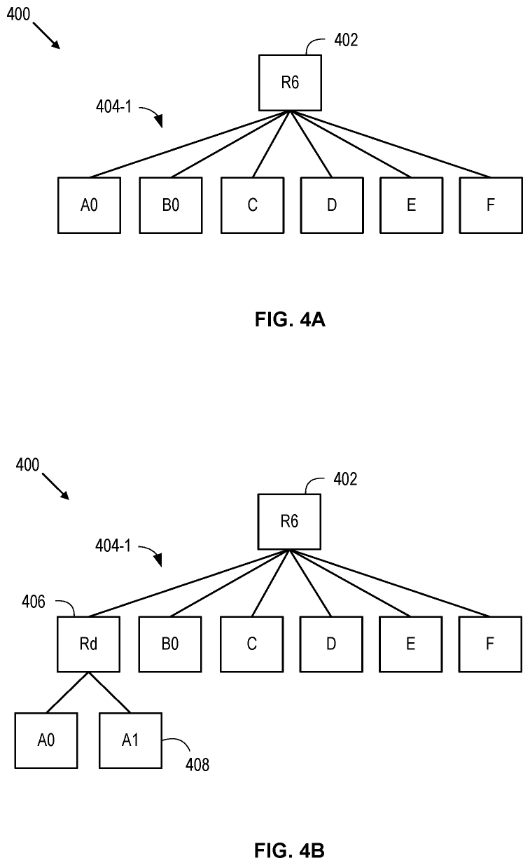

FIG. 4A is a block diagram depicting another RAID tree 400 for a distributed storage object. In the example, the storage policy is FIT set to two, FTM set to erasure coding, and number of stripes set to one. RAID tree 400 includes an RAID6 intermediate node 402 having six components 404-1 designated A0, B0, C, D, E, and F. Assume a failure (planned or unplanned) causes component A0 to become unavailable. In such case, distributed storage software 153 can provision a durability component for A0 using a leaf-mirroring scheme.

FIG. 4B is a block diagram depicting RAID tree 400 of FIG. 4A with a durability component. Distributed storage software 153 creates a RAID_DELTA component 406 for component A0. RAID_DELTA component 406 includes base component A0 and a durability component 408 designated A1.

RAID tree 400 is an example of overlapped address spaces (e.g., different components under a RAID1 or RAID5/6 parent). In embodiments, distributed storage software 153 is capable of creating only one durability object per address space. Thus, only one durability component can be provisioned under the RAID6 node 402. If component A0 becomes unavailable, the durability component A1 provides protection. Afterwards, if component B0 fails transiently followed by component C having a permanent failure, durability component A1 is created without guaranteeing the durability of the object (three failures exceed the FTT of two and the durability component only receives writes for component A0).

The large number of durability components in one group of the RAID configurations (CONCAT, RAID0), and the limited number of durability components in the other group of RAID configurations (RAID1, RAID5, RAID0), are both caused by the leaf-level mirroring scheme. Accordingly, in embodiments, distributed storage software 153 uses an address-space aware technique when placing a durability component in a RAID tree of an object. In further embodiments, distributed storage software 153 uses a per-fault-domain approach to placing durability components. The address-space aware approach and the per-fault-domain approach each minimize durability component footprint while maximizing its usage. These solutions make the vSAN more scalable.

Note that one solution is to employ object-mirrored durability components. Placing one global durability component at the root of the object RAID tree over-simplifies the solution, as it attempts to cover all base components' fault domain failures. This approach will blindly cover all address space segments with an additional leg to write, which not only increases unnecessary input/output cost, but also protecting those components that have plenty of fault domains to fail before losing data. Thus, both the address-space aware approach and per-fault-domain approach described herein exhibit advantages over an object-mirrored approach.

### Address-Space Aware Durability Component Placement

A durability component can be placed some level(s) up in the RAID tree, rather than being at the same level as the base component being protected. The reasons are two-fold: 1) The base component could be much smaller than the maximum size of a component (e.g., 255 GB). A durability component at a higher level in the RAID tree could cover the base component as well as more components on the same level. This results in a saving of the number of delta components placed as long as the whole address space covered on the level of placement is not more than the component maximum size. 2) For RAID0/CONCAT nodes, the children can be placed on a single fault domain. This is due to the fact that the children belong to the same replica. In embodiments, distributed storage software 153 ensures that there is not data for different replicas in the same fault domain in order to achieve the FIT guarantee. Placing a durability component at the RAID0/CONCAT's ancestor node could save the number of deltas, as well as enforce durability for more than one component at the same failing fault domain.

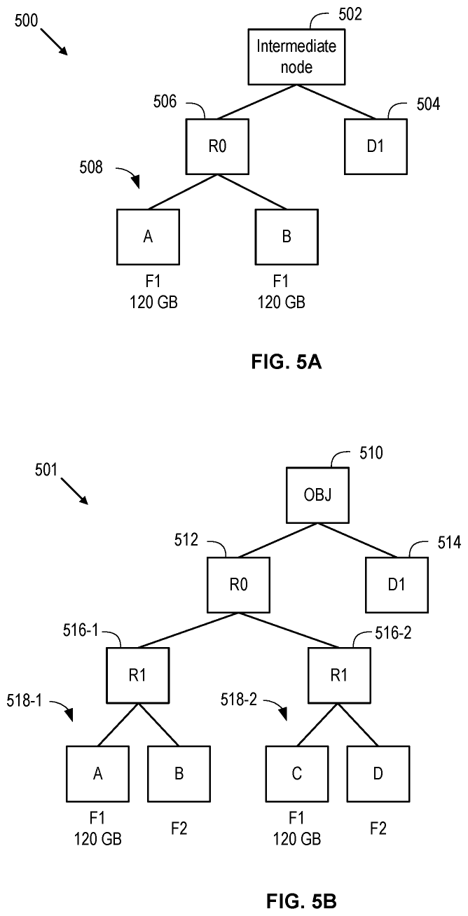

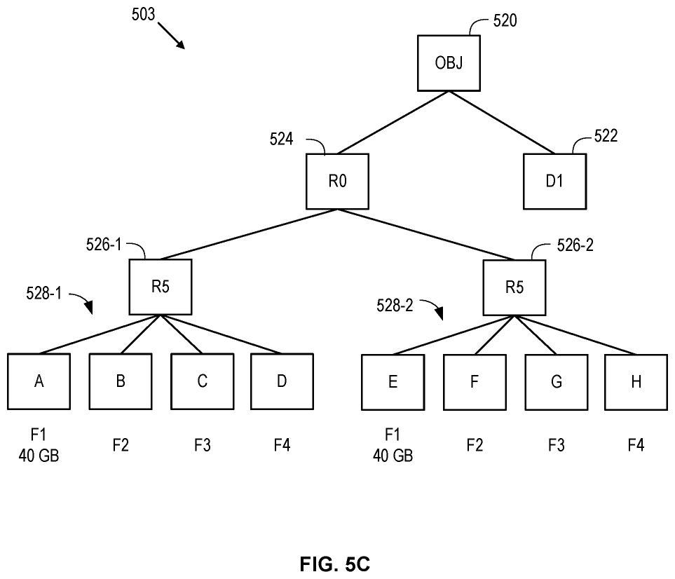

FIGS. 5A-C are block diagrams depicting RAID trees 500, 501 and 503 for distributed storage objects having durability components placed according to embodiments. As shown in FIG. 5A, an object has an intermediate node 502 (other nodes of the object are omitted in this example). RAID tree 500 includes intermediate node 502 as a root node, a RAID0 node 506 as a child of the root node, and two components 508 designated A and B as children of RAID0 node 506. Both components A and B are in the same fault domain designated F1. Each component A and B has a nonoverlapping address space covering 120 GB. Assume for purposes of clarity by example maximum component size is 255 GB. Assume further that a failure leads to component A becoming unavailable. Using the address-space aware approach, distributed storage software 153 can place a delta component 504 (designated D1) on the level of RAID0 node 506. In such case, delta component 504 covers both components A and B. The covered address space is 240 GB, below the 255 GB maximum size for a component. Writes to component A are written to durability component D1 while component A is unavailable. If there is a subsequent failure leading to component B becoming unavailable, writes to component B can be written to durability component D1.

As shown in FIG. 5B, for an object 510, FYI′ is set to two, FTM is set to mirroring, and the number of stripes is two. RAID tree 501 includes object 510 as a root node and a RAID0 node 512 as a child of the root node. One stripe of RAID0 node 512 is stored by RAID1 node 516-1, and the other stripe of RAID0 node 512 is stored by RAID1 node 516-2. RAID1 node 516-1 includes components 518-1 designated components A and B. RAID1 node 516-2 includes components 518-2 designated components C and D. Components A and C are in a fault domain designated F1, and components B and D are in a fault domain designated F2. Assume components A and C each have a nonoverlapping address space covering 120 GB. Assume further that a failure leads to component A becoming unavailable. Using the address-space aware approach, distributed storage software 153 can place a delta component 514 (designated D1) on the level of RAID0 node 512. In such case, delta component D1 covers both components A and C. The covered space is 240 GB, below the 255 GB maximum size for a component (in this example). Writes to component A are written to durability component D1 while component A is unavailable. If there is a subsequent failure leading to component C becoming unavailable, mites to component C can be written to durability component D1. Further, durability component D1 covers both B and D in fault domain F2.

Note that the same holds true if the storage policy for object 510 has FTM set to erasure coding. In such case, RAID1 nodes 516-1 and 516-2 are replaced with RAID5 nodes each having four components in four different fault domains. A durability component at the RAID0 level can protect one base component under each of the RAMS nodes in a given fault domain.

In embodiments, while searching for a best level in the RAID tree in which to place the durability component, there are two constraints: 1) The address space of the merged nodes is less than the maximum component size (e.g., 255 GB); and 2) The address space of the merged nodes covers components of the failed fault domains only. If only the first constraint is satisfied, it is defined as a soft constraint. Satisfying the soft constraint means that distributed storage software 153 may have created a durability object that covers fault domains that are still active. If both constraints are satisfied, it is defined as a hard constraint. Satisfying the hard constraint means that distributed storage software 153 may have created more durability components, but each durability component covers only a failed fault domain (i.e., no active fault domains are covered). In the example of FIG. 5A, the hard constraint is satisfied. In the example of FIG. 5B, the soft constraint is satisfied by placing durability component D1 at the RAID0 level (for cases where the RAID0 legs are RAID1 nodes or RAID5/6 nodes).

As shown in FIG. 5C, for an object 520, FTT is set to one, FTM is set to erasure coding, and the number of stripes is set to two. RAID tree 503 includes object 520 as the root node and a RAID0 node 524 as a child of the root node. One leg of RAID0 node is RAID5 node 526-1, and the other leg of RAID0 node is RAID5 node 526-2. RAID5 node 526-1 has four components 528-1 designated A, B, C, and D. RAID5 node 526-2 has four components 528-2 designated E, F, G, and H. Components A, B, C, and D are in exclusive fault domains designated F1, F2, F3, and F4, respectively. Components E, F, G, and H are in fault domains F1, F2, F3, and F4, respectively. Components A and E each cover 40 GB of nonoverlapping address space. Assume component A is unavailable due to a failure. Distributed storage software 153 can place a durability component 522 (designated D1) at the level of RAID0 node 524. Durability component D1 covers both A and E. However, if multiple fault domains fail at the same time, e.g., A, B, and C failed, durability component D1 covers the additional failures of B and C. In this example, placement of durability component D1 satisfies the soft constraint, since durability component D1 covers an active fault domain F2 when fault domain F1 is unavailable.

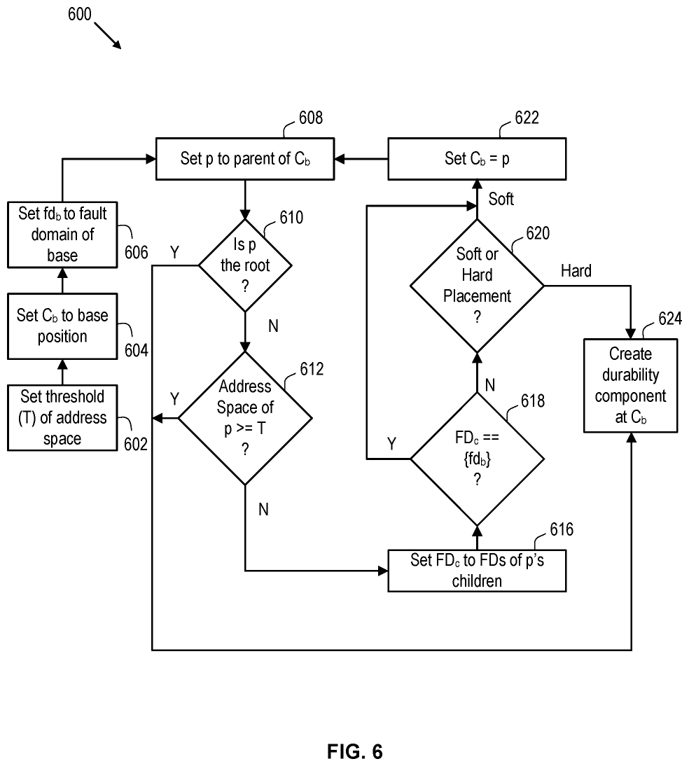

FIG. 6 is a flow diagram depicting a method 600 for address-aware placement of a durability component in a RAID tree of a distributed storage object according to embodiments. Method 600 can be performed by distributed storage software 153 in the event of a failure that leads to component(s) of the distributed storage object to become unavailable. Method 600 begins at step 602, where distributed storage software 153 sets the threshold address space of a component (designated T). The threshold is set to the maximum component size (e.g., 255 GB). At step 604, distributed storage software 153 sets C_{b} to the base component position. At step 606, distributed storage software 153 sets fd_{b} to the fault domain of the base component. At step 608, distributed storage software 153 sets p to the parent node of C_{b}.

At step 610, distributed storage software 153 determines whether p is the root. If so, method 600 proceeds to step 624, where distributed storage software 153 creates a durability component at the level of C_{b}. If p is not the root, method 600 proceeds from step 610 to step 612. At step 612, distributed storage software 153 determines whether the merged address space covered by node p is greater than or equal to the threshold T. If so, method 600 proceeds to step 624, where distributed storage software 153 creates a durability component at the level of C_{b}. Otherwise, method 600 proceeds from step 612 to step 616.

At step 616, distributed storage software 153 sets FD_{c} to a set of fault domains of p's children. At step 618, distributed storage software 153 determines whether FC includes only fd_{b}. If so, method 600 proceeds to step 622, where distributed storage software 153 sets C_{b} to p. Method 600 proceeds from step 622 to step 608. If at step 618 FC_{c} includes more fault domains that fd_{b}, then method 600 proceeds to step 620. At step 620, distributed storage software 153 determines if a hard or soft constraint has been satisfied. If only the soft constraint is satisfied, method 600 proceeds to step 622. If the hard constraint is satisfied, method 600 proceeds to step 624.

### Per-Fault-Domain Durability Component Placement

The address space constraint in the address-aware technique described above is a human-imposed constraint. As technologies and hardware advance, this threshold can be adjusted or eliminated (e.g., the maximum component size can increase or be effectively unbounded). The optimization mode for protecting more data without increasing the number of durability components comes down to identifying the scope of affected components under a failed fault domain. In embodiments, distributed storage software 153 uses a per-fault-domain approach when a fault domain becomes unavailable affecting its components.

In the per-fault-domain approach, the durability component exists on a new fault domain exclusive to the failing fault domain of its corresponding base. There can be many bases on the protection of the same durability component. In this approach, these per-fault-domain durability components will have an object's composite address space, instead of a component's address space. Different base components have different address spaces, and this eliminates the need to manage every base's durability component address space. With one large address space, the management cost is minimized. As a result, the number of durability components will be linear to the number of fault domains this object resides on, which is smaller than the number of components the object has.

When all durability components are created on one active fault domain for one affected fault domain, there is a better chance of keeping the object under a liveness state. With other techniques, if multiple fault domains are used for many durability components, any of them failing could cause the object to lose liveness.

The per-fault-domain durability component encompasses all per-component durability components previously created (probably on different fault domains) on one fault domain for one object. However, the extra cost from the mapping management of which base corresponds to which component-based durability component can be avoided by using the object's composite address space for the per-fault-domain durability component. Note that two base replicas' same composite address space cannot reside on the same fault domain, but the target durability component's fault domain could be the same for the two different replicas. Thus, even one more durability component can be saved because the durability component's fault domain can collide for two protected replicas.

The sparseness of each durability component on a fault domain is likely to be the original object's address space divided by the number of total fault domains touched by this object, assuming even distribution of placement on the original object. The object's barrier will include the durability components as well.

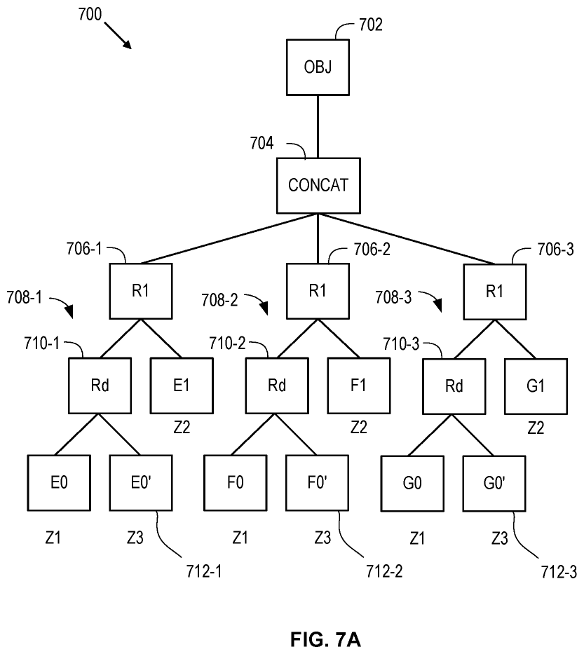

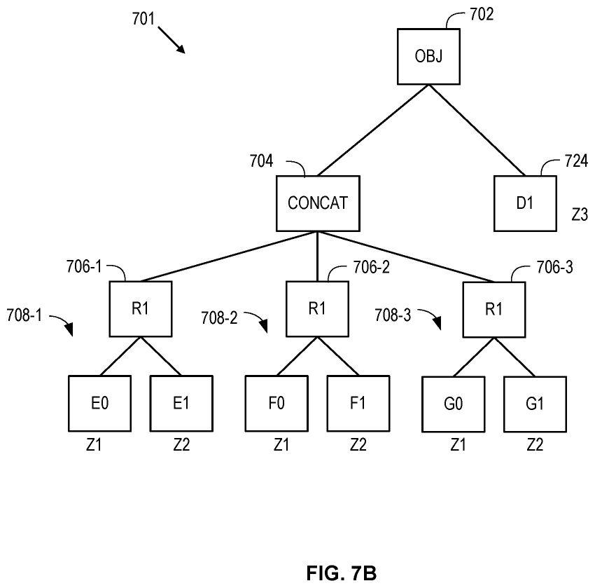

FIG. 7A is a block diagram depicting a RAID tree 700 for an object 702 having durability components placed at the leaf-level. In the example, a CONCAT node 704 includes three legs comprising RAID1 nodes 706-1, 706-2, and 706-3. RAID1 node 706-1 includes components 708-1 designated E0 and E1. RAID1 node 706-2 includes components 708-2 designated F0 and F1. RAID1 node 706-3 includes components 708-3 designated G0 and G1. RAID_DELTA components 710-1, 710-2, and 710-3 are placed at the leaf-level to protect components E0, F0, and G0. This results in durability components 712-1, 712-2 and 712-3 designated E0′, F0′ and G0′ placed at the leaf level. Components E0, F0, and G0 are in a fault domain Z1, which is unavailable. Components E1, F1, and G1 are in an active fault domain Z2. Durability components E0′, F0′ and G0′ are in a fault domain Z3.

FIG. 7B is a block diagram depicting a RAID tree 701 for object 702 having a durability component placed according to a per-fault domain technique according to embodiments. RAID tree 701 is the same as RAID tree 700, except there are no durability components placed at the leaf-level. Instead, a durability component 724 is placed at the level of CONCAT node 704 on a fault domain Z3. If fault domain Z1 fails and components E0, F0, and G0 are all unavailable, only one durability component is created. This is a savings of two durability components compared to leaf-level placement.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of placing a durability component in a redundant array of independent/inexpensive disks (RAID) tree of an object stored in a virtual storage area network (vSAN) of a virtualized computing system, the method comprising:
identifying a base component in the RAID tree that is unavailable due to a failure in the virtualized computing system;
searching the RAID tree, from a level of the base component towards a root of the RAID tree, for a selected level to place a durability component that protects at least the base component, the selected level satisfying at least one of a plurality of constraints; and
provisioning the durability component at the selected level of the RAID tree, the selected level being above the level of the base component in the RAID tree.

2. The method of claim 1, wherein the plurality of constraints include:
a first constraint dictating that a merged address space of nodes in the RAID tree be below the selected level is less than a threshold; and
a second constraint dictating that the merged address space cover one or more components in the RAID tree in one or more failed fault domains.

3. The method of claim 2, wherein the selected level satisfies both the first and the second constraints and the durability component covers only a failed fault domain in the virtualized computing system.

4. The method of claim 2, wherein the selected level satisfies only the first constraint and the durability component covers a failed fault domain in the virtualized computing system and at least one active fault domain in the virtualized computing system.

5. The method of claim 1, wherein the durability component is placed in a fault domain separate from one or more fault domains of components in the RAID tree.

6. The method of claim 1, wherein the durability component placed at the selected level protects at least one additional component than the base component.

7. The method of claim 1, wherein the selected level is a level of a RAID0 node or a concatenation node in the RAID tree.

8. A non-transitory computer readable medium comprising instructions to be executed in a computing device to cause the computing device to carry out a method of placing a durability component in a redundant array of independent/inexpensive disks (RAID) tree of an object stored in a virtual storage area network (vSAN) of a virtualized computing system, the method comprising:
identifying a base component in the RAID tree that is unavailable due to a failure in the virtualized computing system;
searching the RAID tree, from a level of the base component towards a root of the RAID tree, for a selected level to place a durability component that protects at least the base component, the selected level satisfying at least one of a plurality of constraints; and
provisioning the durability component at the selected level of the RAID tree, the selected level being above the level of the base component in the RAID tree.

9. The non-transitory computer readable medium of claim 8, wherein the plurality of constraints include:
a first constraint dictating that a merged address space of nodes in the RAID tree be below the selected level is less than a threshold; and
a second constraint dictating that the merged address space cover one or more components in the RAID tree in one or more failed fault domains.

10. The non-transitory computer readable medium of claim 9, wherein the selected level satisfies both the first and the second constraints and the durability component covers only a failed fault domain in the virtualized computing system.

11. The non-transitory computer readable medium of claim 9, wherein the selected level satisfies only the first constraint and the durability component covers a failed fault domain in the virtualized computing system and at least one active fault domain in the virtualized computing system.

12. The non-transitory computer readable medium of claim 8, wherein the durability component is placed in a fault domain separate from one or more fault domains of components in the RAID tree.

13. The non-transitory computer readable medium of claim 8, wherein the durability component placed at the selected level protects at least one additional component than the base component.

14. The non-transitory computer readable medium of claim 8, wherein the selected level is a level of a RAID0 node or a concatenation node in the RAID tree.

15. A virtualized computing system having a cluster comprising hosts connected to a network, the virtualized computing system comprising:
hardware platforms of the hosts configured to execute software platforms including distributed storage software;
a virtual storage area network (vSAN) comprising local storage devices of the hardware platforms, the vSAN storing an object managed by the distributed storage software, the object including a redundant array of independent/inexpensive disks (RAID) tree;
wherein the distributed storage software is configured to:
identify a base component in the RAID tree that is unavailable due to a failure in the virtualized computing system;
search the RAID tree, from a level of the base component towards a root of the RAID tree, for a selected level to place a durability component that protects at least the base component, the selected level satisfying at least one of a plurality of constraints; and
provision the durability component at the selected level of the RAID tree, the selected level being above the level of the base component in the RAID tree.

16. The virtualized computing system of claim 15, wherein the plurality of constraints include:
a first constraint dictating that a merged address space of nodes in the RAID tree be below the selected level is less than a threshold; and
a second constraint dictating that the merged address space cover one or more components in the RAID tree in one or more failed fault domains.

17. The virtualized computing system of claim 16, wherein the selected level satisfies both the first and the second constraints and the durability component covers only a failed fault domain in the virtualized computing system.

18. The virtualized computing system of claim 16, wherein the selected level satisfies only the first constraint and the durability component covers a failed fault domain in the virtualized computing system and at least one active fault domain in the virtualized computing system.

19. The virtualized computing system of claim 15, wherein the durability component is placed in a fault domain separate from one or more fault domains of components in the RAID tree.

20. The virtualized computing system of claim 15, wherein the durability component placed at the selected level protects at least one additional component than the base component.
